(19) United States
(12) Patent Application Publication
(10) Pub. No.: US 2006/0188669 A1
(43) Pub. Date: Aug. 24, 2006

(54) Interior trim part for interiors of motor vehicles

(75) Inventor: Wolfgang Fischer, Neufahrn (DE)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Lisa Draxlmaier GMBH, Vilsbiburg (DE)

(21) Appl. No.: 11/346,992

(22) Filed: Feb. 3, 2006

(30) Foreign Application Priority Data
Feb. 15, 2005 (DE) 10 2005 006 770.0

(51) Int. Cl. B32B 9/00

(52) U.S. Cl. 428/31; 428/334; 428/411.1

(57) ABSTRACT

A component, in particular an interior trim part for interiors of motor vehicles, having at least one coated contact surface is disclosed. The contact surface contacts at least one other component and on which relative movement occurs. The coating may be a wear-resistant and/or a low-friction coating. The coating may be formed as a two-component coating having a layer thickness of between about 28 μm and about 73 μm. The composition of the coating may have water content of less than about 50%, a solvent content between about 9% and about 10%, and/or a ratio of mixture with a hardener content of between about 10 parts and about 20 parts per 100 parts.

### BACKGROUND

1. Field

Aspects of the invention relate to a component, in particular to an interior trim part for interiors of motor vehicles, coated with a wear-resistant and/or low-friction coating.

2. Discussion of Related Art

With components contacting adjacent components, a problem exists where relative movement between said components results in noise. This usually manifests itself in unpleasant creaking and squeaking noise, and the area of origin often cannot be precisely located due to the sound transmission effect of the components.

To reduce such noises, it is known to provide components with a coating. Such a coating can, for instance, contain solid lubricants, as is the case with the coating disclosed in EP 0 827 867. Such coatings can also contain rubber particles, as suggested in JP 08027409 A.

A disadvantage with prior arrangements is that the application of the coating is very complex. Typically, such coatings are applied by spraying and often require separate first and second coatings. These coatings also tend to be thin.

These two applications result in a considerably complex process in that each coat may require a different coating process. Further, considerable drying time between applications is required. A further disadvantage with thin coatings is that they have a relatively low wear durability, making them susceptible to premature wear under normal driving.

### SUMMARY

In one illustrative embodiment, a component having at least one contact surface on which relative movement with at least one other component occurs is provided. The contact surface includes a coating formed as a two-component coating. The coating has a layer thickness of between about 28 μm and about 73 μm. The coating is formed of a composition comprising a water content of less than 50%, a solvent content of between about 9% and about 10% and a ratio of mixture with a hardener content between about 10 parts and about 20 parts per 100 parts.

Various embodiments of the present inventions provide certain advantages. Not all embodiments of the invention share the same advantages and those that do may not share them under all circumstances.

Further features and advantages of the present inventions, as well as the structure of various embodiments of the present inventions are described in detail below with reference to the accompanying drawings.

### DETAILED DESCRIPTION

One aspect of the invention is directed to a component, such as an interior trim part for automotive interiors, that includes a coating having desired characteristics that can be efficiently applied. In one aspect, the coating provides increased wear-resistance and/or durability. In one aspect, the coating provides reduced friction. In one aspect, the coating reduces the likelihood of noise and/or vibration upon relative movement between the coating-containing component and an adjacent component, which may or may not contain a coating. The coating may be applied in a time-efficient manner and, in one aspect, the drying time of the coating is reduced. It should be appreciated that the present invention is not limited to the above-noted characteristics and that other characteristics may be obtained by the coating. Further, a coating may provide one or more characteristics or any suitable combination of characteristics, as the present invention is not limited in this regard.

In one embodiment, the coating comprises a two-component coating having a layer thickness of between about 28 μm and about 73 μm. In another embodiment, the layer thickness is between about 35 μm and about 65 μm. In yet another embodiment, the layer thickness is between about 45 μm and about 55 μm. In one embodiment, the composition of the coating comprises a water content of less than about 50%. In one embodiment, the coating comprises a solvent content between about 9% and about 10%. In one embodiment, the coating has a ratio of mixture with a hardener content or curing agent content between about 10 parts and about 20 parts per 100 parts. In one embodiment, the hardener comprises a solids content of less than about 78%. In one embodiment, the composition of the coating includes a combination of the above-noted features and/or ingredients.

By employing a coating according to one aspect of the invention, the prior complex dual-layer coating can be omitted without the attendant functional disadvantages and/or intermediate drying times. Moreover, tests have shown that an improved gliding at various temperature ranges is also achieved and that creaking or squeaking noises do not occur.

In one embodiment, the application of the one-layer coating according to the invention can be carried out in conventional painting facilities. Further, such an operation can be performed without having to provide and schedule intermediate drying times. In one embodiment, the coating can be adjusted in a suitable manner and thus may be used in visible areas to achieve an esthetically pleasing result.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only.

What is claimed is:

1. A component having at least one contact surface on which relative movement with at least one other component occurs, the contact surface of the component comprising:
a coating formed as a two-component coating having a layer thickness of between about 28 μm and about 73 μm, and formed of a composition comprising a water content of less than about 50%, a solvent content of between about 9% and about 10% and a ratio of mixture with a hardener content between about 10 parts and about 20 parts per 100 parts.

2. The component according to claim 1, wherein the layer thickness is between about 35 μm and about 65 μm.

3. The component according to claim 1, wherein the layer thickness is between about 45 μm and about 55 μm.

4. The component according to claim 1, wherein the hardener comprises a solids content of less than about 78%.

5. The component according to claim 2, wherein the hardener comprises a solids content of less than about 78%.

6. The component according to claim 3, wherein the hardener comprises a solids content of less than about 78%.

7. The component according to claim 1, wherein the coating is a wear-resistant coating.

8. The component according to claim 1, wherein the coating is a low-friction coating.

9. A part for a motor vehicle comprising the component of claim 1.

10. The part according to claim 9, wherein the component includes a trim piece for the motor vehicle.

11. The part according to claim 10, wherein the trim piece includes an interior trim piece for the motor vehicle.

12. The part according to claim 11, in combination with the motor vehicle.
